(19) United States
(12) Patent Application Publication
(10) Pub. No.: US 2006/0019663 A1
(43) Pub. Date: Jan. 26, 2006

(54) Robust and fast handover in a wireless local area network

(75) Inventors: Angelo Cuffaro, Laval (CA); Vincent Roy, Montreal (CA); Marian Rudolf, Montreal (CA); Paul Marinier, Brossard (CA); Athmane Touag, Chomedey (CA); Christopher Cave, Candiac (CA); Juan Carlos Zuniga, Montreal (CA); Frank LaSita, East Setauket, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/169,491

(22) Filed: Jun. 29, 2005

Related U.S. Application Data
(60) Provisional application No. 60/587,273, filed on Jul. 12, 2004.

(51) Int. Cl. H04Q 7/20

(52) U.S. Cl. 455/436

(57) ABSTRACT

A method for communicating a list of handover candidates in a wireless local area network from a station to a serving access point (AP) begins by determining a list of handover candidate APs at the station. The candidate list is sorted at the station and is sent to the serving AP. The sending step can include sending the candidate list to the serving AP upon the expiration of a predetermined period of time or upon receipt at the station of an event trigger. The method can also include the step of requesting a candidate list from the station by the serving AP.

### CROSS REFERENCE TO RELATED APPLICATION(S)

This application claims the benefit of U.S. Provisional Application No. 60/587,273, filed Jul. 12, 2004, which is incorporated by reference as if fully set forth herein.

### FIELD OF INVENTION

The present invention generally relates to wireless local area networks (WLANs), and more particularly, to a method for performing a robust and fast handover in a WLAN.

### BACKGROUND

A handover event can typically be separated into three separate phases. First, in the discovery phase, candidate access points (APs) are identified and sorted in order of attractiveness, which implies that the link quality and the radio frequency (RF) environment are monitored. Second is the triggering phase, in which a decision is made to initiate a handover, which also implies that the link quality and the RF environment are monitored. Third is the execution of the handover, in which the radio connection between a station (STA) and the old AP is broken and a radio connection is established with the new AP. In WLAN systems, the execution phase of a handover may include, but is not limited to: authentication/pre-authentication with the new AP, security key management with the new AP, Quality of Service (QoS) negotiations with the new AP, re-association, and redirecting buffered traffic from the old AP to the new AP.

The typical architecture of WLAN systems deployed in infrastructure mode (versus ad-hoc mode) uses a distribution system in which the APs of an extended service set (ESS) are connected through a wired link. Since many of the tasks that have to be performed during the execution phase of a handover include signaling, it is desirable to have the serving AP perform this signaling with the new candidate AP, as the two APs can take advantage of the privileged wired link, also called a distribution system, rather than have the STA use the less reliable wireless medium to communicate with both the old AP and the new APs. This is reinforced by the fact that users in handover situations have a higher probability than other users of being in a location where they perceive less than ideal transmission conditions (e.g., the STA is more likely to be at the edge of the coverage area of the cell). Moreover, the growing use of WLAN systems to provide Quality of Service (QoS)-oriented applications such as Voice over Internet Protocol (VoIP) and other delay-sensitive applications puts stricter requirements on the speed at which a handover must be performed. This makes it desirable to perform some of the tasks associated with handover execution prior to triggering the handover, such as pre-authentication, security key management, QoS negotiations, etc., which would benefit from being performed over the distribution system rather than using the wireless medium (for capacity, speed, and reliability reasons).

On the other hand, the STA is in a privileged position to monitor the radio links because it is directly experiencing the variations of propagation conditions in the RF environment while moving. This privileged position for simultaneously monitoring the radio connections and the time-varying RF environments makes it attractive to have the monitoring and the triggering phase of the handover performed at the STA. Locating these functionalities at the STA can maximize the probability that the handover decision is taken at the right moment and that the new AP chosen for the handoff is indeed the best candidate from the STA's perspective.

In summary, the RF environment combined with the architecture typically used in deployed WLAN systems makes it attractive to have some of the handover functionalities located in the STA and some of the handover functionalities in the AP. The current state of the art, including the WLAN standards, does not provide a resolution to this problem.

### SUMMARY

The present invention provides a means for directing a handover by the STA, but where the AP can perform many of the tasks associated with the execution phase of the handover. The invention includes a method by which the STA indicates to the serving AP the list of APs that the STA is considering as potential candidates for an eventual handoff. The list of APs is sorted according to metrics monitored at the STA. This procedure can take place periodically or can be event-driven such as when the STA wishes to handover. The invention also includes a method by which the STA can request the AP to initiate the execution of a handover and by which the AP can signal the outcome of the handover request back to the STA. The invention further includes a method by which the serving AP can request a STA to send the candidate list of APs.

A method for communicating a list of handover candidates in a WLAN from a STA to a serving AP begins by determining a list of handover candidate APs at the STA. The candidate list is sorted at the STA and is sent to the serving AP. The sending step can include sending the candidate list to the serving AP upon the expiration of a predetermined period of time or upon receipt at the STA of an event trigger. The method can also include the step of requesting a candidate list from the STA by the serving AP.

A method for initiating a handover in a WLAN by a STA on the network, begins by sending a list of candidate APs from the STA to a serving AP. The STA requests the serving AP to initiate a handover. A determination is made whether the serving AP can complete the handover, and the handover is performed by the serving AP if the serving AP can complete the handover.

A system for exchanging handover information in a WLAN includes a STA and an AP. The STA includes a first antenna; a first transmitter/receiver communicating with the network via the first antenna; a handover candidate list creation device communicating with the first transmitter/receiver; a handover candidate list sorting device communicating with the handover candidate list creation device and the first transmitter/receiver; a candidate list measuring device communicating with the handover candidate list creation device and the first transmitter/receiver; and a handover request device communicating with the first transmitter/receiver. The AP includes a second antenna; a second transmitter/receiver communicating with the network via the second antenna; a handover candidate list device communicating with the second transmitter/receiver; a handover execution device communicating with the handover candidate list device and the second transmitter/receiver; and an additional information request device communicating with the handover execution device and the second transmitter/receiver.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIGS. 1A and 1B are flowcharts of methods for a STA to communicate a list of handover candidate APs to its serving AP;

FIG. 2 is a flowchart of a method for a STA to request its serving AP to initiate a handover;

FIG. 3 is a flow diagram of a method for a serving AP to request a handover candidate list from an associated STA; and

FIG. 4 is a block diagram of a system for exchanging handover information.

### DETAILED DESCRIPTION OF THE PREFERRED EMBODIMENTS

Hereafter, the term “station” (STA) includes, but is not limited to, a wireless transmit/receive unit, a user equipment, a mobile station, a fixed or mobile subscriber unit, a pager, or any other type of device capable of operating in a wireless environment. When referred to hereafter, the term “access point” (AP) includes, but is not limited to, a base station, a Node B, a site controller, or any other type of interfacing device in a wireless environment.

The invention includes three methods:

(1) A method by which the STA indicates to the serving AP what APs it is considering as potential candidates for an eventual handoff. The list of APs is sorted according to metrics monitored at the STA. This procedure can take place periodically or can be event-driven.

(2) A method by which the STA can request the AP to initiate the execution of a handover and by which the AP can signal back to the STA the outcome of the handover request.

(3) A method by which the serving AP can request a STA to send the candidates list.

These methods can be implemented by, but are not limited to, an additional dedicated management frame or control frame; or a signaling message transmitted as the payload of standard data frames, control frames, or management frames. These frames can be standard medium access control (MAC) frames.

Neighbor information can be indicated in MAC frames by bit flags, by an information element (IE), by a message field part on an existing or new IE, or by using reserved (currently unused) values in any existing IE or field of a MAC frame. Neighbor information can be added to any location in the MAC frame, in the header or the body using any of the mechanisms described. In one preferred embodiment of the present invention, neighbor information is sent from the STA to the AP in a MAC frame of management sub-type, although this method can be employed without loss of usefulness even if other subtypes of MAC frames are used.

I. Method by which the STA communicates to the AP a list of handover candidates

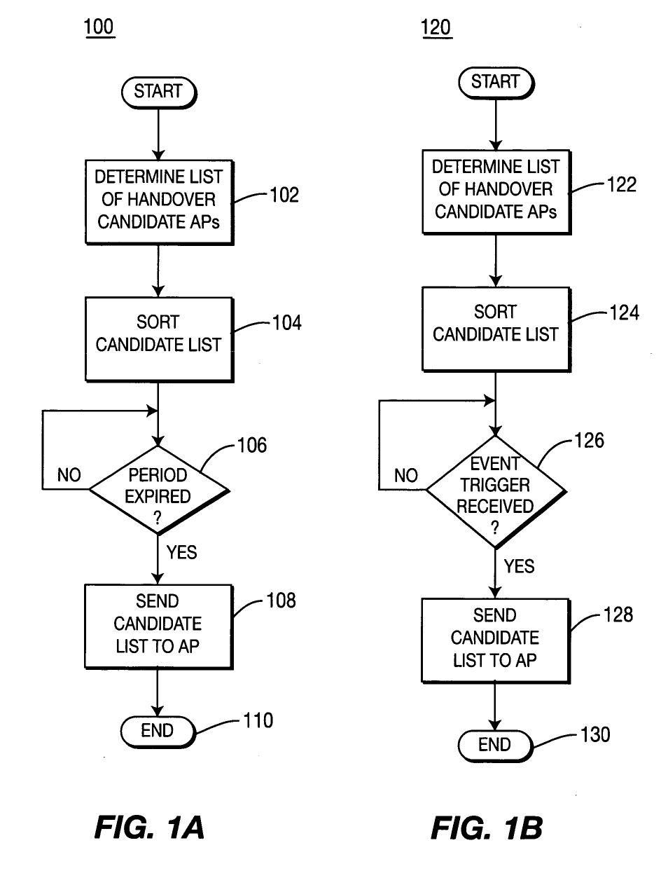

FIG. 1A is a flowchart of a method 100 for sending a candidate AP list from a STA to the serving AP on a periodic basis. The method 100 begins with the STA determining a list of handover candidate APs (step 102). The STA then sorts the candidate list (step 104). A determination is made whether the reporting period has expired (step 106). If the reporting period has not expired, then the method 100 waits at step 106 until the reporting period has expired. Once the reporting period has expired, the STA sends the sorted candidate list to the AP (step 108) and the method terminates (step 110).

With the periodic reporting, increasing the rate at which candidate lists are sent improves the quality of the monitoring and the robustness of the radio connection. However, there is a drawback in that frequently sending candidate lists imposes a greater signaling overhead on the system. In a preferred embodiment, the period for sending candidate lists can range from 0.1 seconds to 10 seconds.

FIG. 1B is a flowchart of a method 120 for sending a candidate AP list from a STA to the serving AP on an event-driven basis. The method 120 begins with the STA determining a list of handover candidate APs (step 122). The STA then sorts the candidate list (step 124). A determination is made whether an event trigger has been received (step 126). If an event trigger has not been received, then the method 120 waits at step 126 until an event trigger is received. Once an event trigger has been received, the STA sends the sorted candidate list to the AP (step 128) and the method terminates (step 130).

The trigger events can include, but are not limited to:

(a) when the STA wishes to trigger a handover;

(b) when the STA measures that the quality of the radio link (as measured using received signal power, signal-to-interference ratios, signal-to-noise ratios, packet error rate, medium access delays, channel occupancy, throughput, etc.) between itself and its associated AP falls below a certain pre-determined threshold;

(c) after a predetermined number of failed beacon receptions;

(d) when the STA measures that the quality of the radio link(s) it would perceive with one or multiple candidate lists would be superior to the quality it measures on its current radio link with the serving AP;

(e) when the STA is moving from the serving AP towards other AP(s);

(f) upon the expiration of a periodic timer; or

(g) any combination of the above triggers.

The candidate list created by the STA (steps 102, 122) is typically derived from measurements taken at the STA. Examples of measurements that are used by the STA to create the list of candidate APs include, but are not limited to, the following measurements or combinations of the following measurements:

(1) received signal power measured from the beacon, probe responses, or any other frames transmitted from the neighboring APs;

(2) signal-to-interference ratios or signal-to-noise ratios estimated from the beacon, probe responses, or any other frames transmitted from the neighboring APs;

(3) packet error rate or bit error rate measured on the beacon, probe responses, or any other frames transmitted from the neighboring APs; and

(4) medium access delays, channel occupancy, throughput, or other load-related metrics that the STA can estimate by scanning the channels used by neighboring APs or that the STA can receive from neighboring APs through measurement reporting.

The candidate list created by the STA could also be derived by other means, including Operation and Maintenance (O&M), in which the user or network administrator configures the STA with a fixed list of candidates; or by signaling from another entity in the radio network, such as an access router or an AP.

The candidate list may be sorted by the STA (steps 104, 124) according to metrics that include, but are not limited to, received power from the candidate AP or signal to noise ratio (SNR) perceived by the STA; a load metric such as channel occupancy, number of packets or bytes transferred per unit of time, etc.; and service capabilities, such as security, QoS support, etc. The metrics used by the STA to sort the candidate list can also include the measurements that are used to derive the candidate list, as described above.

In addition to the candidate AP list, the STA may also send a list of measurements taken by the STA from each AP on the candidate list and a list of parameters associated to each candidate AP, where the parameters are known by the STA from listening to broadcast frames or other forms of control or management frames. Examples of the measurements include received power, SNR, signal to interference ratio (SIR), load metrics, etc. Examples of the parameters include, but are not limited to, the address of the AP, the ESSID, the basic service set (BSS) ID (BSSID), service capabilities, security capabilities, etc.

II. Method by which a STA can request the AP to initiate the execution of a handover and by which the AP can signal the outcome of the handover request back to the STA

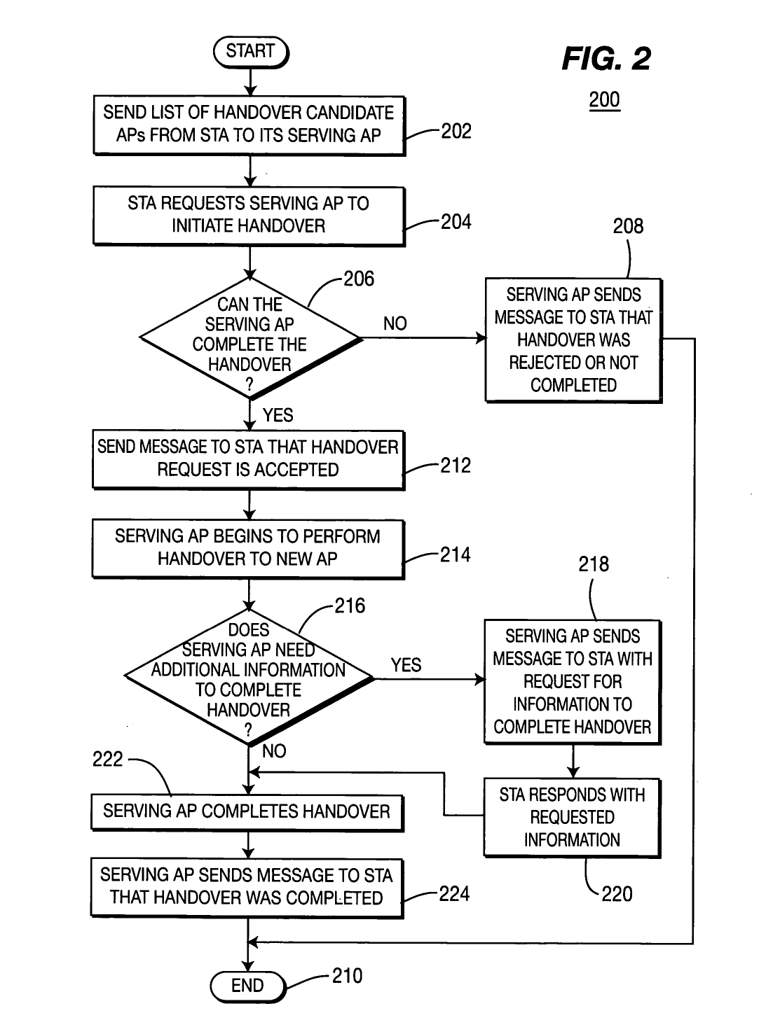

FIG. 2 is a flowchart of a method 200 for a STA to request its serving AP to initiate a handover. The method 200 begins with the STA sending a list of handover candidate APs to its serving AP (step 202). The STA requests its serving AP to initiate a handover (step 204). The request may include a time limit or delay under which the actions have to be performed. A determination is made whether the serving AP can complete the handover (step 206). If the serving AP cannot complete the handover, the serving AP sends a message to the STA indicating the handover was rejected or was not completed (step 208) and the method terminates (step 210). The message may also include the reason why the serving AP rejected or could not complete the handover request. Some example reasons why the handover request would be rejected or not completed include, but are not limited to, the serving AP not finding any neighboring APs; the APs on the candidate list are not responding; the neighboring AP are too congested in terms of traffic; and the neighboring AP does not support the required capabilities in terms of security, support for QoS, support of services required for the on-going connection, etc.

If the serving AP can complete the handover (step 206), the serving AP sends a message to the STA that the handover request has been accepted (step 212) and begins to perform the handover to a new AP (step 214). A determination is made whether the serving AP needs additional information from the STA in order to complete the handover (step 216). If the serving AP needs additional information, the serving AP sends a message to the STA containing a request for the additional information (step 218) and the STA responds with the requested information (step 220). This information can include the procedure or necessary information to complete the handover. The additional information could include updated measurements taken by the STA, new measurements from the STA and requested by the new AP, or more detailed information about the status of the on-going radio connection (e.g., average throughput at the transmitter, average throughput at the receiver, average traffic load generated by the STA, size of queued or buffered data to be transmitted by the STA, etc.).

If the serving AP does not need any additional information (step 216) or has been supplied with the additional information (step 220), the serving AP completes the handover (step 222). The serving AP then sends a message to the STA that the handover to the new AP has been completed (step 224). This message can include any information relevant to the accepted or completed handover, such as the identity of the new AP or parameters proper to the new AP, such as addresses, capabilities, key management procedures, etc. The method then terminates (step 210). It is noted that the message that the handover is completed (step 224) can be sent by either the old serving AP or the new serving AP.

III. Method by which a serving AP can request a STA to send a candidate list

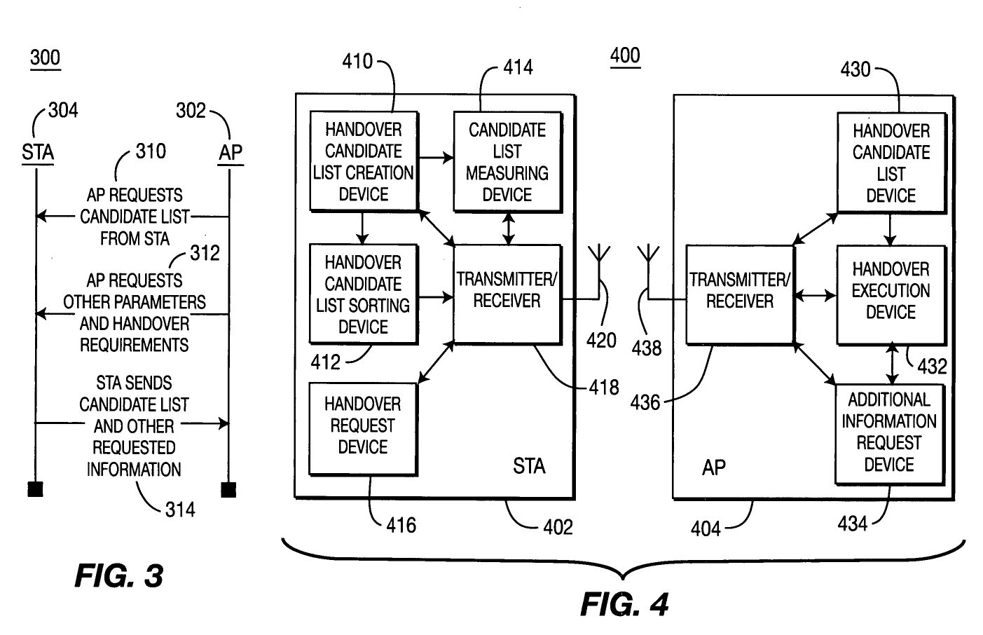

FIG. 3 is a flow diagram of a method 300 for a serving AP 302 to request a handover candidate list from an associated STA 304. The method 300 begins with the AP 302 requesting a candidate list from the STA 304 (step 310). The AP can also request a list of measurements, other parameters, and handover requirements from the STA 304 (step 312). It is noted that the candidate list request message (step 310) and the measurement request message (step 312) could be combined into a single message. The STA 302 sends the candidate list and other requested information to the AP 302 (step 314). In addition to the candidate list, the STA can also send information relating to a time limit or delay under which the actions have to be performed.

The three methods described above are somewhat inter-dependent in the sense that one builds over another. For instance, Method 1 relates to a STA sending candidate lists to an AP. Method 3 relates to an AP requesting a candidate list from the STA, and therefore builds on top of Method 1. Method 2 discloses one way where a system could benefit from having the monitoring and triggering functionalities at the STA and the execution functionalities at the AP. Method 1 relates to Method 2 in the sense that it provides an interface by which the STA can communicate the output of the monitoring it is responsible for to the AP. Method 2 also covers a special message that allows the STA to request the AP to perform the handover (aside from the candidate list). Although these methods can be used in conjunction with one another, they can also be used separately.

IV. System for exchanging handover information

FIG. 4 is a block diagram of a system 400 for exchanging handover information, as described in connection with the methods shown in FIGS. 1-3. The system 400 includes a STA 402 and an AP 404. The STA 402 includes a handover candidate list creation device 410, a handover candidate list sorting device 412, a candidate list measuring device 414, a handover request device 416, a transmitter/receiver 418, and an antenna 420. The AP 404 includes a handover candidate list device 430, a handover execution device 432, an additional information request device 434, a transmitter/receiver 436, and an antenna 438.

The system 400 operates as follows. The STA 402 creates a handover candidate list using the handover candidate list creation device 410. The list is passed to the handover candidate list sorting device 412 for sorting. The list may also be passed to the candidate list measuring device 414 to add measurements regarding each AP on the candidate list taken by the STA 402. After the list has been sorted (and the optional measurements added to the list), the list is passed to the transmitter/receiver 418 where it is transmitted to the AP 404 via the antenna 420. The handover request device 416 is used when the STA 402 is going to initiate a handover by sending a handover request message to the AP 404.

The handover candidate list device 430 in the AP 404 receives the candidate list from the STA 402 via the antenna 438 and the transmitter/receiver 436. The handover candidate list device 430 can also request a candidate list from the STA 402 by sending a request message. The handover execution device 432 receives the candidate list from the handover candidate list device 430 and begins executing a handover. The handover execution device 432 also receives handover initiation requests from the handover request device 416 in the STA 402. Upon completion of a handover, the handover execution device 432 notifies the STA 402 of the result. If additional information is needed by the handover execution device 432 to complete the handover, the additional information request device 434 sends a request for information to the STA 402. The STA 402 responds with the additional information and the additional information request device 434 passes the additional information to the handover execution device 432.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for communicating a list of handover candidates in a wireless local area network from a station to a serving access point (AP), comprising the steps of:
determining a list of handover candidate APs at the station;
sorting the candidate list at the station; and
sending the candidate list to the serving AP.

2. The method according to claim 1, wherein the determining step includes selecting potential candidate APs based upon measurements taken by the station.

3. The method according to claim 1, wherein the determining step includes using a fixed list of candidate APs.

4. The method according to claim 1, wherein the determining step includes the station receiving the candidate list from another entity on the network.

5. The method according to claim 1, wherein the sorting step includes sorting the candidate list by measurements taken at the station.

6. The method according to claim 1, wherein the sorting step includes sorting the candidate list by metrics relating to each AP on the list.

7. The method according to claim 1, wherein the sending step includes sending the candidate list to the serving AP upon the expiration of a predetermined period of time.

8. The method according to claim 7, wherein the predetermined period of time is between 0.1 seconds to 10 seconds.

9. The method according to claim 1, wherein the sending step includes sending the candidate list to the serving AP upon receipt at the station of an event trigger.

10. The method according to claim 9, wherein the event trigger includes the station triggering a handover.

11. The method according to claim 9, wherein the event trigger includes a quality of the radio link between the station and the serving AP falling below a pre-determined threshold.

12. The method according to claim 9, wherein the event trigger includes the station identifying an AP on the candidate list with a superior radio link quality than the serving AP.

13. The method according to claim 9, wherein the event trigger includes the station moving from the serving AP towards another AP.

14. The method according to claim 1, further comprising the step of:
requesting a candidate list from the station by the serving AP.

15. The method according to claim 14, further comprising the step of:
requesting parameters and handover requirements from the station by the serving AP.

16. A method for initiating a handover in a wireless local area network by a station on the network, comprising the steps of:
sending a list of candidate access points (APs) from the station to a serving AP;
requesting the serving AP to initiate a handover by the station;
determining whether the serving AP can complete the handover;
performing the handover by the serving AP if the serving AP can complete the handover.

17. The method according to claim 16, further comprising the step of:
sending a message from the serving AP to the station indicating whether the serving AP can complete the handover.

18. The method according to claim 17, wherein if the serving AP cannot complete the handover, the message includes a reason why the serving AP could not complete the handover.

19. The method according to claim 16, further comprising the step of:
determining whether the serving AP requires additional information from the station to complete the handover.

20. The method according to claim 19, wherein if the serving AP requires additional information to complete the handover, the method further comprising the steps of:
requesting the additional information from the station by the serving AP; and
responding to the request by the station with the additional information.

21. The method according to claim 16, further comprising the step of:
sending a message from the serving AP to the station that the handover has been completed.

22. A system for exchanging handover information in a wireless local area network, comprising:
a station, comprising:
a first antenna;
a first transmitter/receiver communicating with the network via said first antenna;
a handover candidate list creation device communicating with said first transmitter/receiver;
a handover candidate list sorting device communicating with said handover candidate list creation device and said first transmitter/receiver;
a candidate list measuring device communicating with said handover candidate list creation device and said first transmitter/receiver; and
a handover request device communicating with said first transmitter/receiver; and
an access point, comprising:
a second antenna;
a second transmitter/receiver communicating with the network via said second antenna;
a handover candidate list device communicating with said second transmitter/receiver;
a handover execution device communicating with said handover candidate list device and said second transmitter/receiver; and
an additional information request device communicating with said handover execution device and said second transmitter/receiver.
